(19) United States
(12) Patent Application Publication
(10) Pub. No.: US 2008/0277419 A1
(43) Pub. Date: Nov. 13, 2008

(54) Fluid Dispenser

(75) Inventors: David A. Holcomb, Seattle, WA (US); Jonah S. Griffith, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Chef'n Corporation, Seattle, WA (US)

(21) Appl. No.: 12/005,161

(22) Filed: Dec. 21, 2007

Related U.S. Application Data
(60) Provisional application No. 60/876,695, filed on Dec. 21, 2006.
(60) Provisional application No. 60/934,222, filed on Jun. 11, 2007.

(51) Int. Cl. B67D 5/56; B67D 5/52; B67D 5/60; B67D 5/06

(52) U.S. Cl. 222/129; 222/145.5; 222/135; 222/205

(57) ABSTRACT

Apparatuses and methods for dispensing at least one fluid are shown and described. Embodiments are operable to produce a mixture formed of desired fluids. The mixture can then be poured for subsequent use.

### CROSS-REFERENCES TO RELATED APPLICATIONS

This application claims the benefit under 35 U.S.C. § 119(e) of U.S. Provisional Patent Application No. 60/876,695 filed Dec. 21, 2006 and U.S. Provisional Patent Application No. 60/934,222 filed Jun. 11, 2007, where these two provisional applications are incorporated herein by reference in their entireties.

### BACKGROUND

1. Field of the Disclosure

The invention relates to apparatuses and methods for processing at least one substance. More particularly, the invention relates to a dispenser for dispensing one or more fluids.

2. Description of the Related Art

Liquids, such as oil and vinegar, are often combined to produce a tasty consumable mixture. Such a mixture can be used as a dip for bread, pizza crust, etc. Oil and vinegar are often stored in separate bottles so that a user can separately pour the liquids to produce a mixture having the desired ratio of oil to vinegar. It is often difficult to achieve a desired proportion in such a mixture, especially with bottles that do not regulate the flow of fluid therefrom. Other types of liquids (e.g., syrups, vinegars, and condiments) can likewise be stored in separate bottles.

### BRIEF SUMMARY

Some embodiments disclosed herein are generally directed towards apparatuses and methods for dispensing one or more substances. In particular, some embodiments of dispensers allow a user to combine one or more substances (e.g., edible substances) before delivering the mixture from the dispenser. A user can visually inspect the mixture held in an inner chamber of the dispenser to confirm whether the mixture has the desired constituents. Once a desired mixture is produce in the chamber, the mixture can be shaken and/or delivered out of the dispenser for subsequent consumption. Additionally or alternatively, the dispensers can be used to dispense a single substance.

The dispensers can be filled with various types of substances with a wide range of physical characteristics. The substances, for example, can be flowable substances. Even though the substances flow, various types of particles (e.g., seeds, leaves, herbs, and the like) can be carried or entrained in the substance.

In some embodiments, a handheld pitcher includes a main body having an opening and a bottom opposing the opening. A plurality of liquid holding reservoirs are inside of the main body. Each of the liquid holding reservoirs is fluidly separated from the other reservoirs. A holding chamber is disposed in the main body and in fluid communication with the plurality of liquid holding reservoirs. A fluid flow regulating system (e.g., a manual system) is configured to selectively deliver fluid independently from each of the liquid holding reservoirs into the holding chamber. In some embodiments, the liquid holding reservoirs are between the holding chamber and the bottom.

In some embodiments, a portable liquid dispenser includes an outer body defining an opening adapted to pour a liquid from the dispenser and a bottom opposing the opening. A plurality of liquid holding receptacles are in the outer body. A holding chamber is in the outer body and in fluid communication with the opening. A pumping system is configured to deliver liquids from each of the plurality of holding receptacles into the holding chamber.

In other embodiments, a handheld liquid dispenser includes a body defining an upper opening in which fluid can flow through and a lower bottom adapted for placement on a support surface. A plurality of reservoirs and a chamber is in the body of the dispenser. The chamber is in fluid communication with the upper opening, and a plurality of fluid pathways extends from the plurality of liquid holding reservoirs to the chamber.

In some embodiments, a method of preparing a mixture in a handheld bottle comprises independently delivering liquids from a plurality of liquid holding reservoirs in an outer body of the handheld bottle into a holding chamber of the handheld bottle to produce a mixture. The mixture is delivered out of the bottle by pouring the mixture through an opening of the bottle.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility.

FIG. 1 is a perspective view of a fluid dispenser, according to one illustrated embodiment.

FIG. 2 is a plan view of the fluid dispenser of FIG. 1.

FIG. 3A is a cross-sectional view of the fluid dispenser taken along a line 3A-3A of FIG. 2.

FIG. 3B is a plan view of a bottom section of the fluid dispenser of FIG. 3A taken along the line 3B-3B.

FIG. 4A is a cross-sectional view of the fluid dispenser taken along a line 4A-4A of FIG. 2, wherein a lid is in a closed position.

FIG. 4B is a cross-sectional view of the fluid dispenser taken along a line 4B-4B of FIG. 2, wherein the lid is in an open position.

FIG. 5 is a side elevational view of a fluid dispenser, according to one illustrated embodiment.

FIG. 6 is a front elevational view of a fluid dispenser, according to one illustrated embodiment.

FIG. 7 is a side elevational view of a fluid dispenser, according to one illustrated embodiment.

FIG. 8 is a rear elevational view of a fluid dispenser, according to one illustrated embodiment.

FIG. 9 is a bottom view of a fluid dispenser, according to one illustrated embodiment.

FIG. 10 is a perspective view of a fluid dispenser, according to one illustrated embodiment.

FIG. 11 is a cross-sectional view of a fluid dispenser filled with two substances, according to one illustrated embodiment.

FIG. 12 is a partial cross-sectional view of the fluid dispenser wherein a mixture of the two substances in FIG. 11 is in a holding chamber.

FIG. 13 is a perspective view of a fluid dispenser, according to one illustrated embodiment.

FIG. 14 is a plan view of the fluid dispenser of FIG. 13.

FIG. 15 is an elevational cross-sectional view of the fluid dispenser taken along a line 15-15 of FIG. 14.

FIG. 16 is a detailed cross-sectional view of the fluid dispenser taken along the line 15-15 of FIG. 14.

FIG. 17 is a side elevational view of a fluid dispenser, according to one illustrated embodiment.

FIG. 18 is a front elevational view of a fluid dispenser, according to one illustrated embodiment.

FIG. 19 is a side elevational view of a fluid dispenser, according to one illustrated embodiment.

FIG. 20 is a rear elevational view of a fluid dispenser, according to one illustrated embodiment.

FIG. 21 is an isometric view of a portion of a fluid dispenser, according to one illustrated embodiment.

FIG. 22 is an isometric view of a portion of a fluid dispenser, according to one illustrated embodiment.

FIG. 23 is an isometric view of a portion of a fluid dispenser, according to one illustrated embodiment.

### DETAILED DESCRIPTION OF THE INVENTION

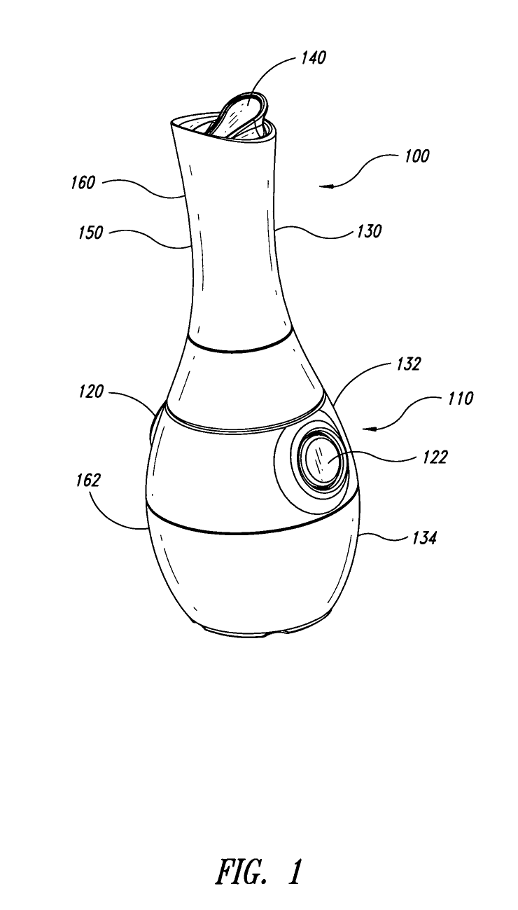

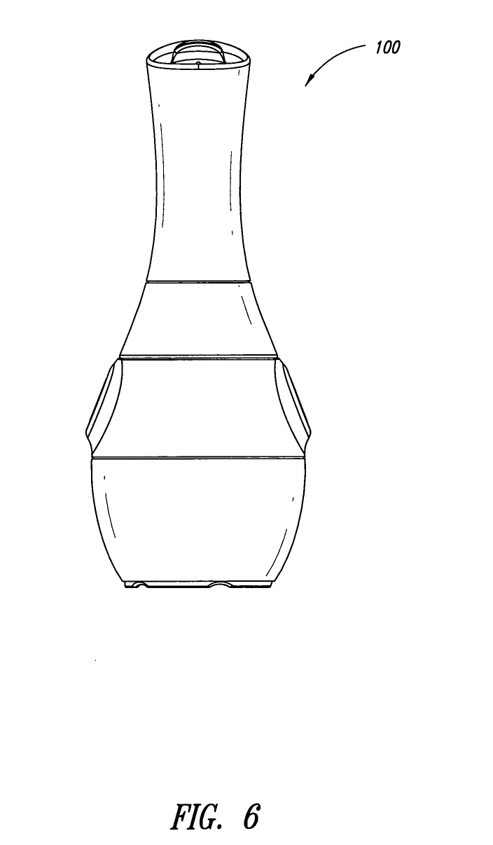

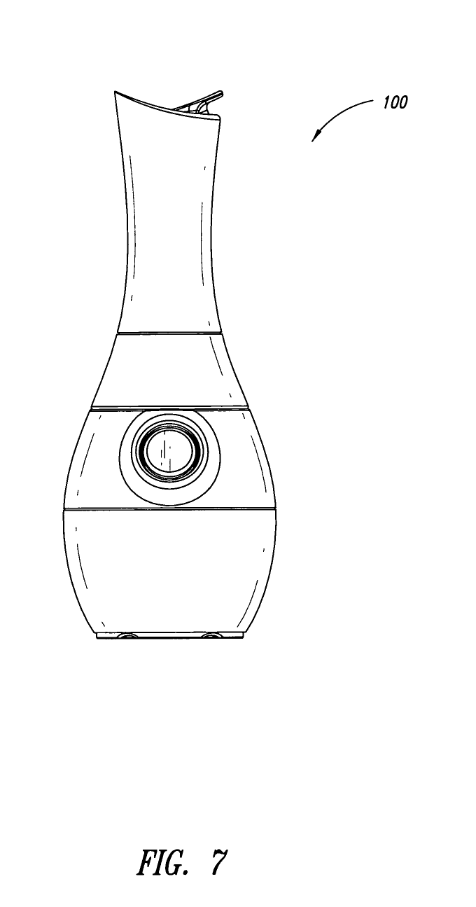

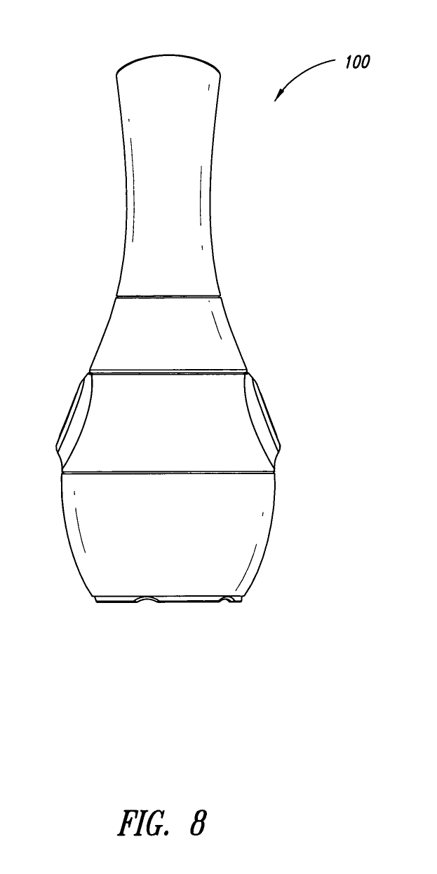

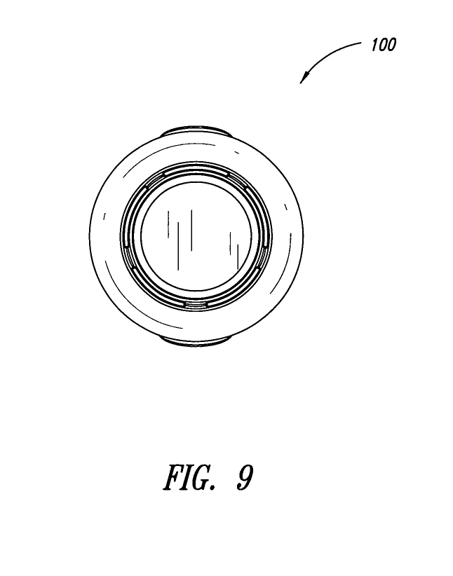

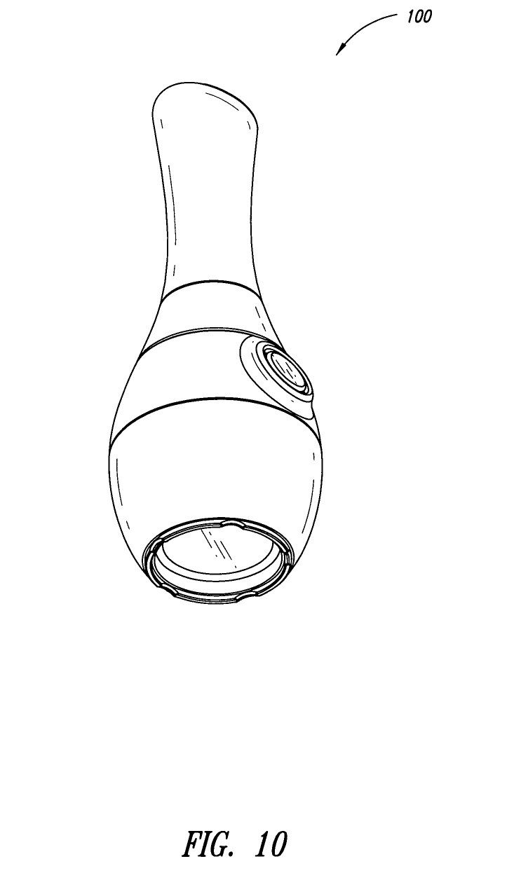

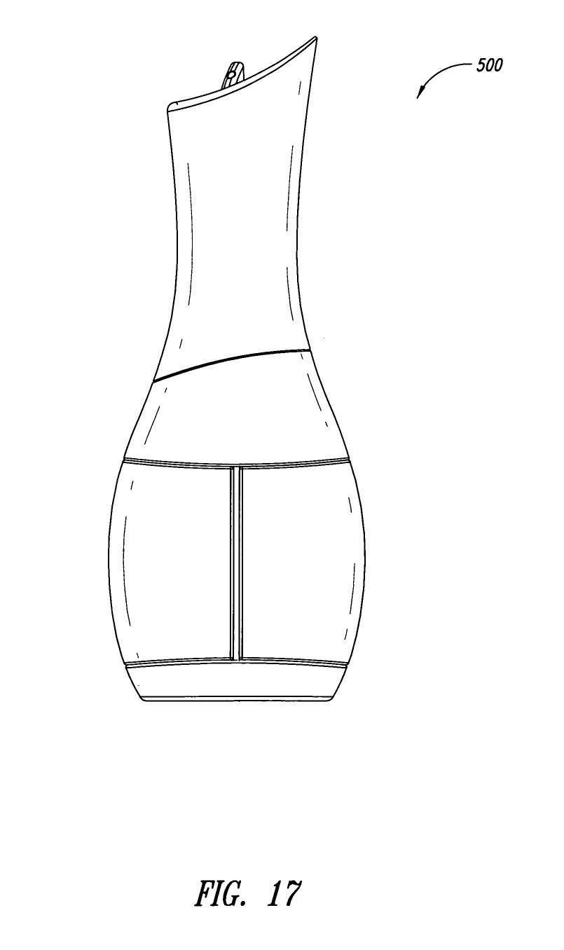

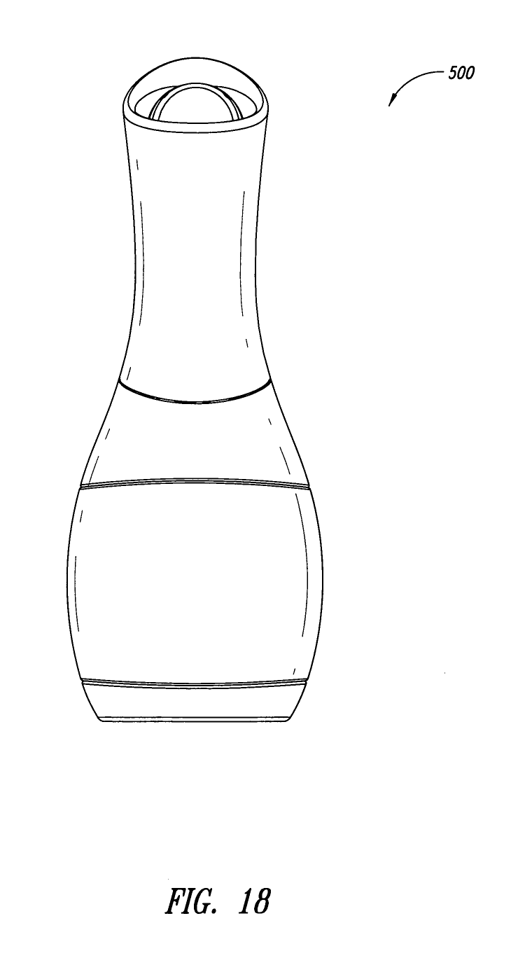

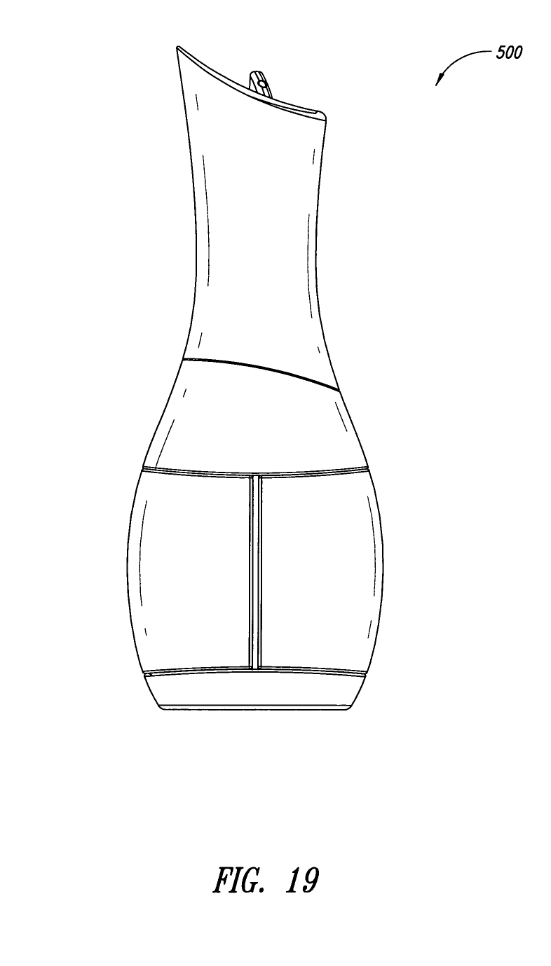

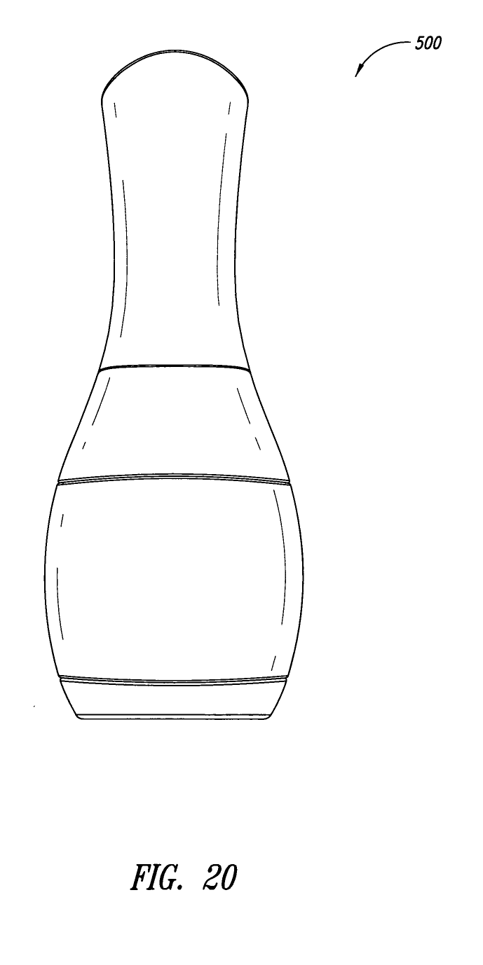

The present detailed description is generally directed towards apparatuses and methods for processing (e.g., separating, combining, mixing, dispensing, combinations thereof, and the like) one or more substances. Embodiments disclosed herein may be used to meter desired amounts of one or more substances into a holding or mixing chamber. The mixture can then be delivered out of the dispenser via an opening (e.g., a pour spout). Many specific details of certain embodiments of the invention are set forth in the following description and in FIGS. 1-23 to provide a thorough understanding of such embodiments. One skilled in the art, however, will understand that these embodiments may have additional features or may be practiced without one or more of the details described in the following description.

It should be noted that, as used in this specification and the appended claims, the singular forms “a,” “an,” and “the” include plural referents unless the context clearly dictates otherwise. For example, a liquid holding reservoir may include a single liquid holding reservoir or a plurality of liquid holding reservoirs. It should also be noted that the term “or” is generally employed in its sense including “and/or” unless the content clearly dictates otherwise.

FIGS. 1 to 10 illustrate a portable, handheld dispenser 100 configured to hold one or more substances therein. The substances can remain isolated from one another to maintain desired characteristics (e.g., flavor). Advantageously, the dispenser 100 can be used to process at least one of the substances for subsequent consumption. The term “process” is broadly construed to include, without limitation, to meter, to separate, to combine, to mix, to agitate, to dispense, combinations thereof, and the like. Various types of processes can be performed depending on the substances contained in the dispenser 100. The dispenser 100 can be operated to achieve a mixture with a desired taste and other criteria often used in food preparation. The dispenser 100 is described in the context of dispensing liquids because of its particular utility in this context; however, other types of substances can be used with the dispenser 100 in a similar manner.

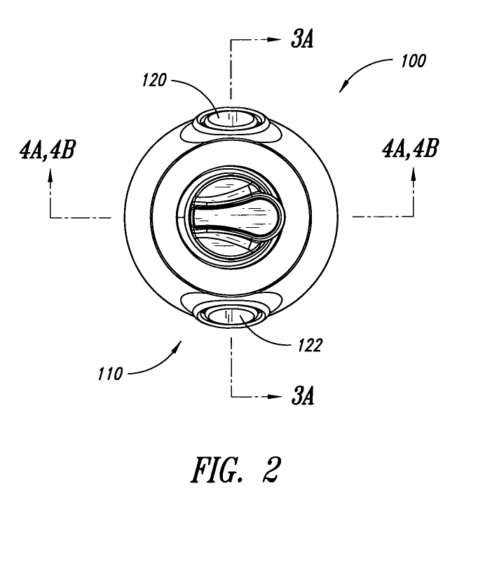

With continued reference to FIGS. 1 and 2, a pump system 110 having actuatable elements 120, 122 is operable to produce mixtures having different amounts of constituent fluids. The mixture can then be poured out of the dispenser 100. In some embodiments, the dispenser 100 can selectively meter a single fluid into an internal holding chamber (not shown). The isolated fluid can then be poured out of the dispenser 100.

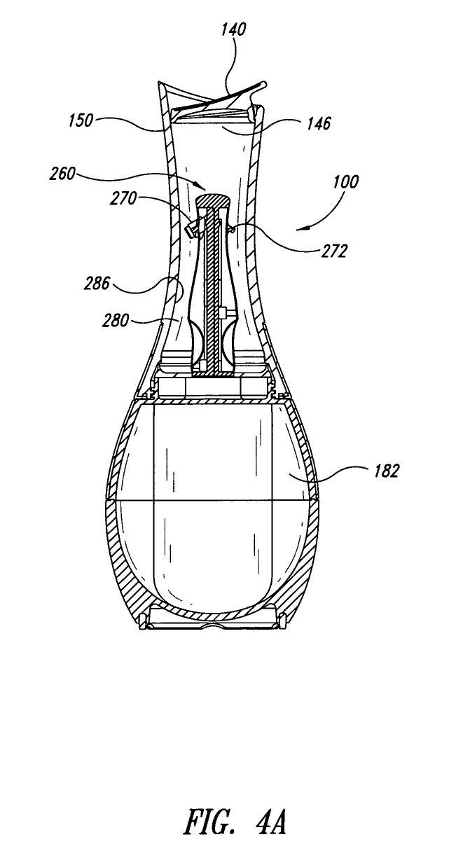

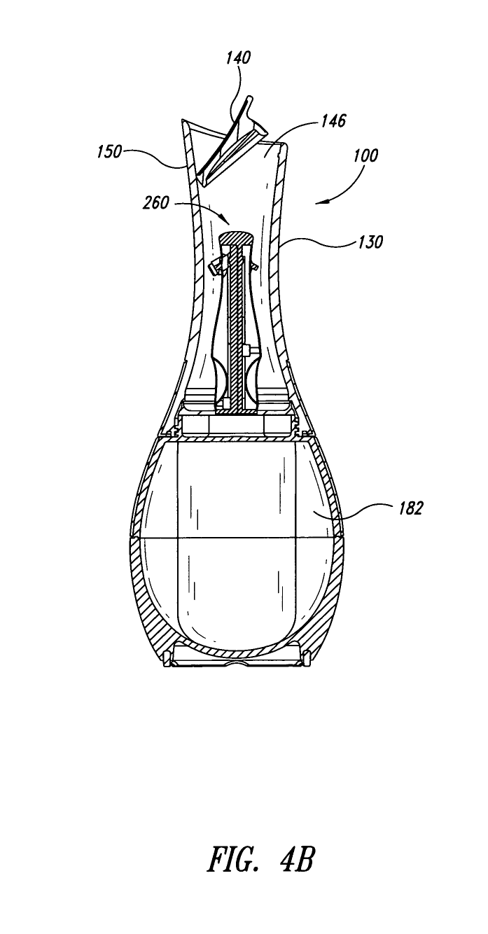

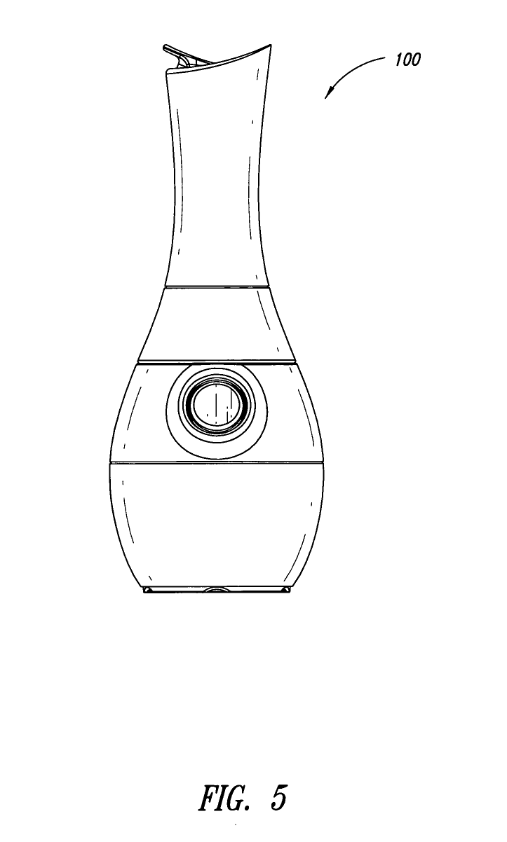

The illustrated dispenser 100 of FIG. 1 includes a holding section 130, central section 132, and lower section 134 for resting on a support surface. The holding section 130 includes a movable lid 140 for covering an opening 146 (FIG. 4B). The lid 140 can be pivoted between an open position (FIG. 4B) for pouring liquid from the dispenser 100 and a closed position (FIG. 4A) for blocking, either partially or completely, the opening 146. The illustrated lid 140 of FIGS. 4A and 4B is hingedly coupled to an outer body 150 of the dispenser 100.

Referring again to FIG. 1, the pump system 110 is positioned along the central section 132 and is operable to delivery a desired amount of liquid from the lower section 134 into the holding section 130. The handheld dispenser 100 can be manually tipped until the mixture flows from the holding section 130 out of dispenser 100.

The dispenser 100 can be in the form of a cruet, pitcher, bottle, or jug, as well as other types of containers suitable for holding at least one substance. The shape of the dispenser 100 can be selected based on the desired holding capacity of the dispenser 100, number of fluids held therein, and its intended use.

The illustrated outer body 150 of the dispenser 100 has a tapered neck 160 and an expanded lower body 162. A user can comfortably and securely grip the tapered neck 160 in order to transport and manipulate the dispenser 100. The expanded lower body 162 defines a relatively large internal volume suitable for accommodating various types of liquids. The outer body 150 can also have other shapes. For example, the outer body 150 can have a generally cylindrical shape.

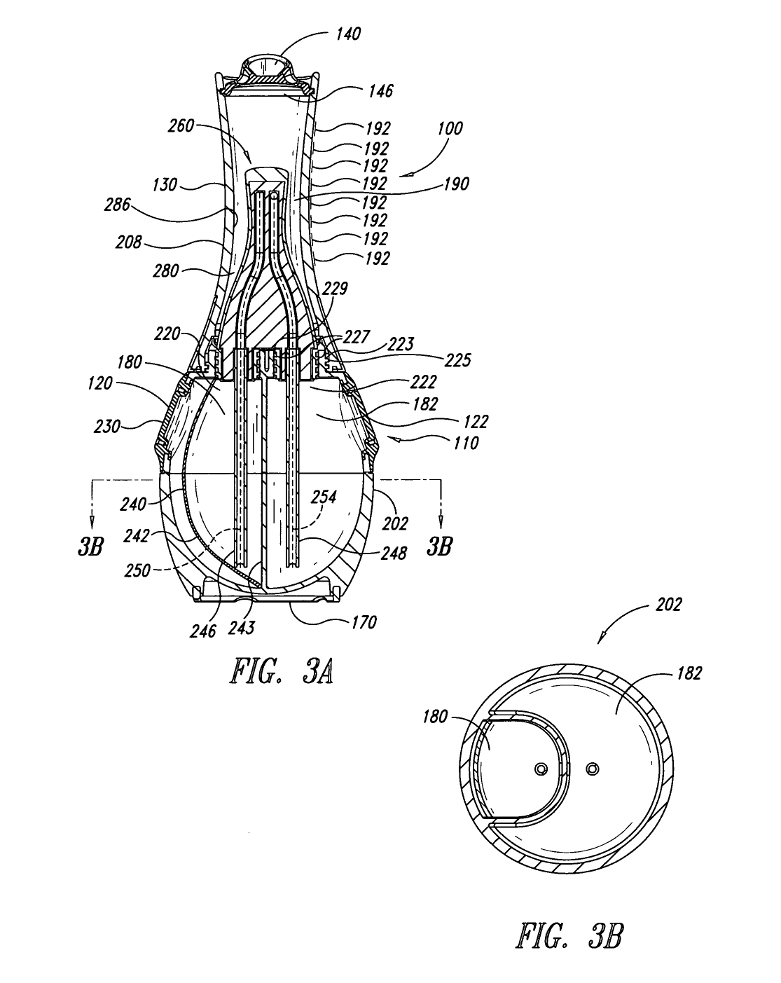

With reference now to FIG. 3A, the handheld dispenser 100 includes a bottom 170 opposing the opening 146. The illustrated bottom 170 is somewhat flat for resting on a somewhat flat support surface. A plurality of fluid holding reservoirs 180, 182 are disposed inside of the outer body 150. Each of the reservoirs 180, 182 can hold a desired amount of fluid. In other embodiments, the dispenser 100 can have more than two reservoirs, each reservoir configured to store a particular liquid. The reservoirs can keep the liquids separate to prevent mixing, thereby maintaining proper flavor characteristics of the liquids. The fluidly separated liquids can therefore maintain their flavor for extended periods of time.

The illustrated reservoir 182 of FIGS. 3A and 3B has a greater holding capacity than the reservoir 180. Because mixtures of oil and vinegar often include more oil than vinegar, the large reservoir 182 can hold oil and the small reservoir 180 can hold vinegar. The relative sizes of the reservoirs 180, 182 can be selected based on the expected proportion of the fluids delivered from the dispenser 100.

In some embodiments, the reservoirs 180, 182 can have the same or similar holding capacities. One or more removable or permanent liners, bladders, pouches, and the like can form at least a portion of the reservoirs 180, 182.

In order to view the contents of the dispenser 100, at least a portion of the outer body 150 can be made of a somewhat transparent material, preferably an optically clear material. In some embodiments, for example, the tapered neck 160 can be made, in whole or in part, of an optically clear material such that a user can visually inspect any contents therein. Visual inspection can be useful to determine when a proper mixture has been produced in a foodstuff holding chamber 190. The mixture may be a heterogeneous mixture (e.g., a mixture of oil and vinegar, oil and lemon juice, and the like), homogeneous mixture (e.g., two flavored syrups, two vinegars, and the like), emulsifier, and combinations thereof. If the mixture does not have the desired number or proportion or constituents, the pump system 110 is used to adjust the number and/or proportion of its constituents until a desired mixture has been produced.

A bottom section 202 of FIG. 3A of the dispenser 100 can likewise be made, in whole or in part, of a transparent material such that a user can easily determine when to refill one or both of the reservoirs 180, 182. An upper section 208 can be detached from the bottom section 202 to expose upper openings 220, 222 of the reservoirs 180, 182, respectively. In such refillable embodiments, the dispenser 100 can be refilled any number of times with various types of substances, such as oil (e.g., olive oil, cooking oil, and the like), vinegar (e.g., rice vinegar, balsamic vinegar, malt vinegar, and the like), juice (e.g., lemon juice), syrup (e.g., flavored syrups for coffee, beverages, and the like), sauce (e.g., soy sauce, hot sauce, and the like), ketchup, mustard, dressing (e.g., salad dressing), and other condiments. It is recognized that other types of substances can also be used with the dispenser 100.

Coupling features 223, 225 of FIG. 3A can detachably couple the bottom section 202 to the upper section 208. The illustrated coupling features 223, 225 are threads that mate with each other such that the upper section 208 can be twisted onto and off of the bottom section 202. Flexible engagement members 227 of the upper section 208 can engage receiving sections 229 of the bottom section 202 to ensure a proper fit. In some embodiments, fluid-tight seals can be formed between the engagement members 227 and the receiving sections 229.

The dispenser 100 can have optional measuring indicia 192 (shown in FIG. 3A) for determining the amount of fluid in a chamber 190 ready for dispensing. The illustrated indicia 192 are a series of markings (e.g., generally horizontal lines) spaced vertically from one another. Each marking can correspond to a known volume. Such a graduated section of the dispenser 100 can facilitate proper measuring of fluids. The measuring indicia 192 can be formed by printing, embossing, etching, stamping, or other marking techniques. Additionally or alternatively, other portions of the dispenser 100 can also have measuring markers. For example, the holding reservoirs 180, 182 can include visible measuring indicia.

The dispenser 100 can have various types of rotary or reciprocating pumping systems based on the desired pumping action. The pumping systems, for example, can be manually driven via one or more movable handles, levers, buttons, flexible panels or walls, and the like. Internal components, such as reservoirs, pouches, bladders, chambers, conduits, lines, and the like, can be chosen based on the characteristics of the fluid to be pumped. To pump high viscosity liquids, the pumping system may be able to achieve relative high back pressures as compared to pumping systems for pumping low viscosity liquids.

The pump system 110 can independently deliver fluid from each of the holding reservoirs 180, 182 into the holding chamber 190, defined in the holding section 130 and proximate the opening 146. In some embodiments, the pump system 110 delivers a single fluid from one of the reservoirs 180, 182 into the holding chamber 190 for. In other embodiments, fluids from each of the holding reservoirs 180, 182 are combined in the holding chamber 190. The number of reservoirs can be selected based on the number of fluids desired for cooking, producing edible mixtures (e.g., sauces, dips, and the like), or for other uses known in the art.

The pump system 110 of FIGS. 2 and 3A has a pair of diametrically opposing actuatable elements 120, 122 capable of driving liquid out of the reservoirs 180, 182, respectively. Each of the actuatable elements 120, 122 can be moved between a first position (e.g., the illustrated neutral position) to a second depressed position to drive fluid out of the respective reservoirs 180, 182. The actuatable elements 120, 122 can be generally similar to each other and, accordingly, the following description of one of the actuatable elements applies equally to the other, unless indicated otherwise.

With continued reference to FIG. 3A, the actuation element 120 includes a movable outer button 230. When the user depresses the button 230 inwardly, the volume of the reservoir 180 (illustrated as U-shaped in FIG. 3B) is reduced until at least a portion of the fluid in the reservoir 180 flows through a fluid line 246. In this manner, a desired amount of fluid in the reservoir 180 can be driven therefrom into the holding chamber 190. Once a desired amount of fluid has been pumped, the button 230 can return to its initial position such that the pumping process can be repeated. Ambient air outside the dispenser 100 can be drawn into the reservoir 180 to replace the volume of liquid delivered into the holding chamber 190.

The illustrated button 230 is integrally formed with the bottom section 202 through, for example, a molding process (e.g., an injection molding process). Various types of flexible resilient materials (e.g., polymers, rubbers, composites, combinations thereof, and the like) can be used to form, in whole or in part, the button 230 and the bottom section 202. The flexible material can allow convenient displacement of the button 230 but biases the depressed button 230 towards the initial position (shown in FIG. 3A).

To further enhance actuation of the button 230, one or more biasing members can be employed. When a user depresses the button 230, a biasing member can be displaced inwardly towards the reservoir 180. Once the user reduces the applied pressure, such biasing member can return the button 230 to the initial position.

The pump system 110 of FIG. 3A also includes a pair of fluid lines 246, 248 extending between the holding chamber 190 and the reservoirs 180, 182, respectively. The fluid line 246 defines a flow path 250 from the reservoir 180 to the holding chamber 190. The fluid line 248 defines a flow path 254 from the reservoir 182 to the holding chamber 190. Various types of flexible, semi-flexible, or rigid conduits can be used to form the fluid lines 246, 248.

Referring to FIGS. 3A to 4B, a manifold system 260 can extend through the holding chamber 190. As shown in FIG. 4A, the manifold system 260 includes outputs 270, 272 for delivering fluid flowing through the fluid lines 246, 248, respectively. The fluid lines 246, 248, for example, can extend from the reservoirs 180, 182 to the outputs 270, 272. Other configurations can also be employed.

A space 280 is defined between the manifold system 260 and an inner surface 286 of the main body 150. To reduce, limit, or substantially prevent unwanted splattering of the fluid from the manifold system 260 during the pumping process, the outputs 270, 272 each direct the flow of liquid downwardly away from the opening 146.

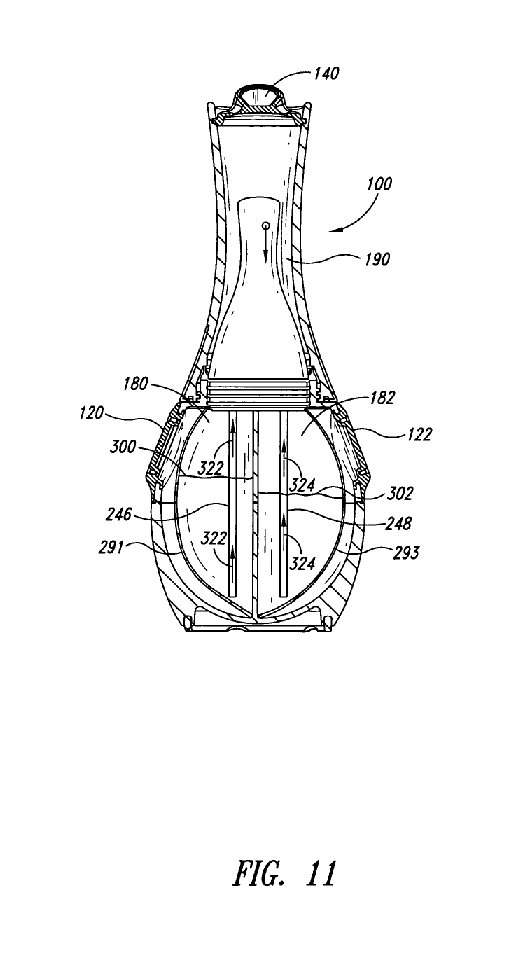

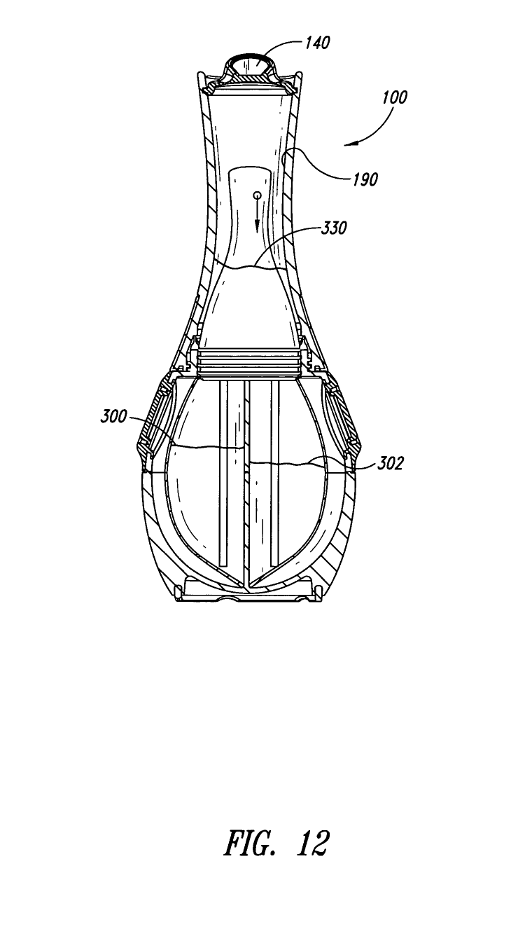

FIGS. 11 and 12 show one embodiment of using the dispenser 100. The side-by-side reservoirs 180, 182 are filled with a first liquid 300 and a second liquid 302, respectively. The illustrated reservoirs 180, 182 are formed, at least in part, by internal bladders 291, 293, respectively. The actuatable elements 120,122 can be used to displace the flexible internal bladders 291, 293, respectively, to controllably drive fluid from one or both of the reservoirs 180, 182.

The first and second liquids 300, 302 can be different liquids such as oil and vinegar. The holding capacities of the reservoirs 180, 182, alone or combined, can be greater than the holding capacity of the holding chamber 190. These large capacity reservoirs 180, 182 are especially well suited for holding enough liquid to fill repeatedly the holding chamber 190 without being refilled.

The actuatable elements 120, 122 can be operated concurrently or sequentially to fill the holding chamber 190. To produce a mixture having generally equal amounts of the liquids 300, 302, the actuatable elements 120, 122 can be operated (e.g., displaced) the same number of times. To adjust the ratio of the first liquid 300 to the second liquid 302, the actuatable elements 120, 122 can be operated a different numbers of times. In the illustrated embodiment of FIG. 11, the actuatable element 120 is operated to drive the first liquid 300 upwardly through the fluid line 246 (indicated by the arrows 322) and the manifold system 260 and outwardly into the holding chamber 190. The actuatable element 122 is likewise operated to drive the second liquid 302 upwardly through the line 248 (indicated by the arrows 324) and the manifold system 260 and outwardly into the holding chamber 190.

FIG. 12 shows the isolated mixture 330 in the holding chamber 190. To further mix the mixture 330, the user can manually shake the dispenser 100. The lid 140 can inhibit or substantially prevent escaping of the mixture 330 from the dispenser 100. In some embodiments, the user can apply pressure to the lid 140 to limit unwanted movement of the lid 140.

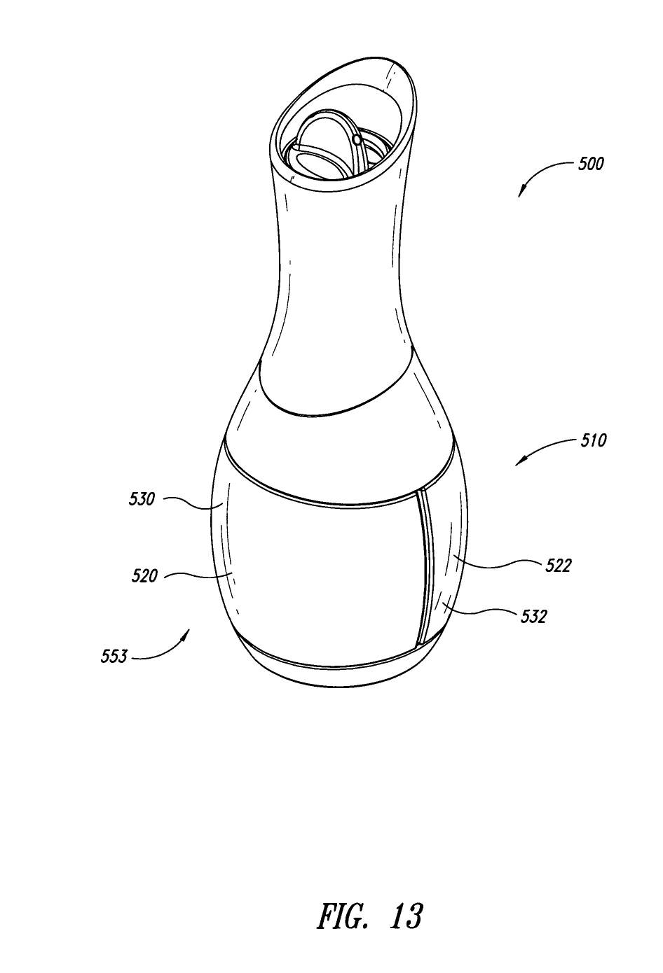

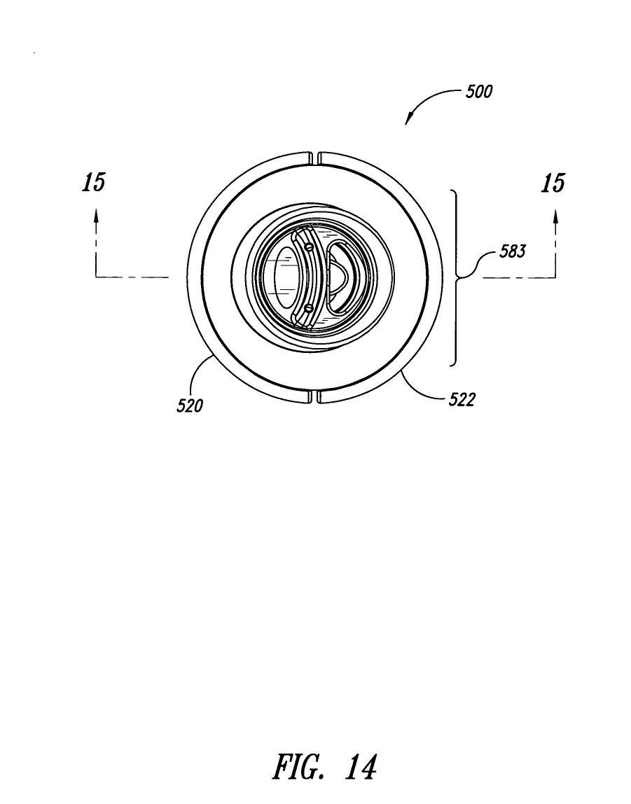

FIG. 13 shows a dispenser 500 that includes a pump system 510 having actuatable elements 520, 522 in the form of flexible wall portions. The actuatable elements 520, 522 define relatively large contact surfaces 530, 532, respectively. A user can manually engage the opposing contact surfaces 530, 532 to manually operate the pump system 510.

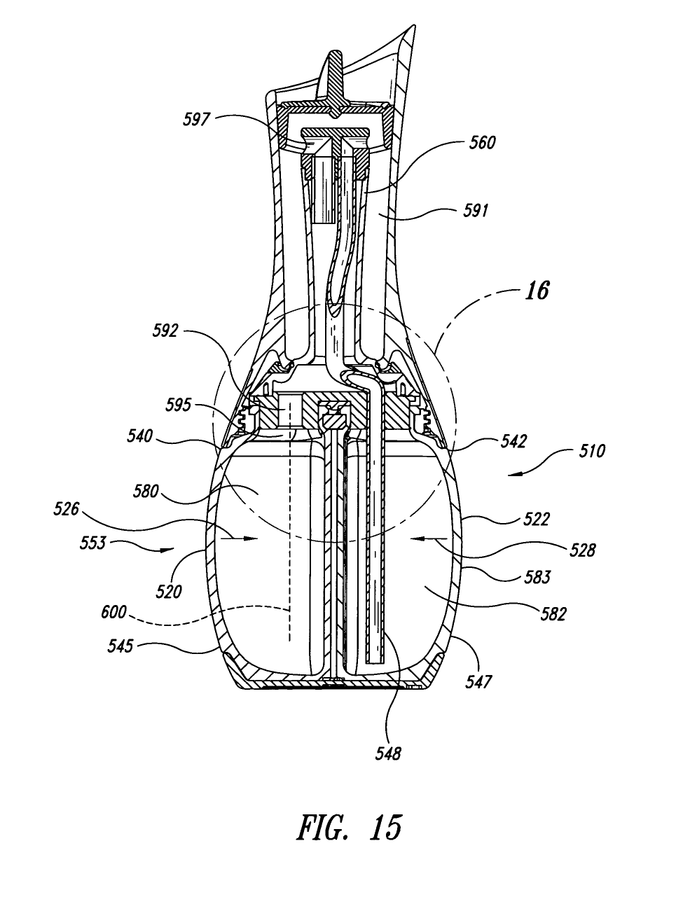

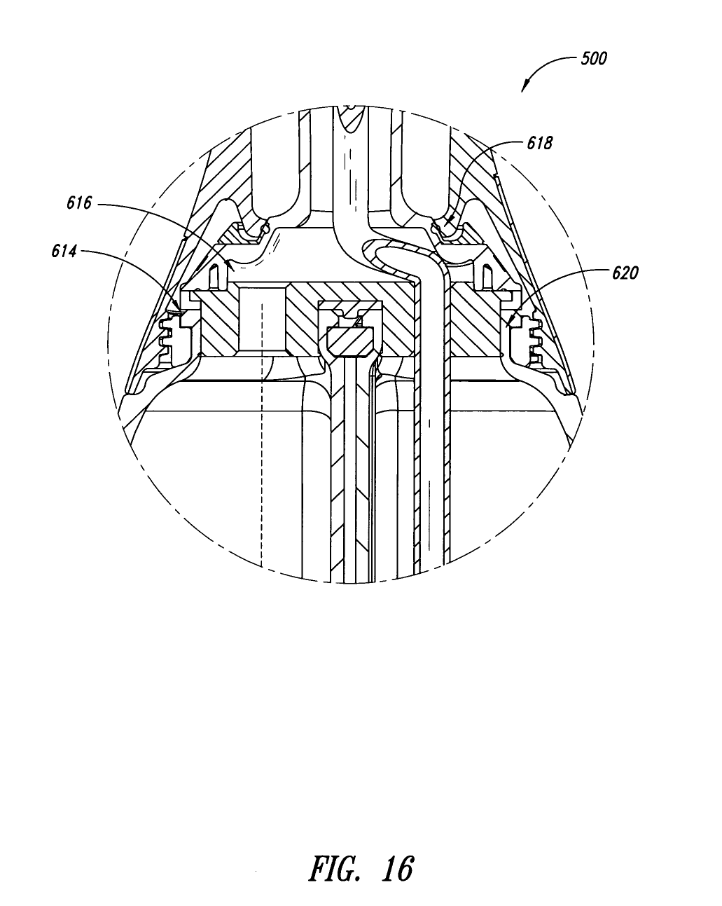

Referring to FIGS. 14 and 15, the flexible actuatable elements 520, 522 are curved so as to define somewhat arcuate contact surfaces 530, 532 (e.g., as viewed from above and/or from the side). One or both actuatable elements 520, 522 can be displaced inwardly (indicated by the arrows 526, 528 of FIG. 15) to dispense or meter fluid from corresponding reservoirs 580, 582. To dispense fluid held in the reservoir 582, for example, a central section 583 of the convex actuatable element 522 can be pushed radially inward. To dispense a relatively large amount of fluid, the central section 583 can be depressed inwardly until it bulges into the reservoir 582 a desired distance. The actuatable elements 520, 522 can be pumped any number of times to dispense a selected amount of fluid.

In some embodiments, the actuatable elements 520, 522 have a height that is approximately equal to a height of one or both of the fluid reservoirs 580, 582. In some embodiments, including the illustrated embodiment of FIG. 15, the actuatable elements 520, 522 have respective upper ends 540, 542 proximate to the respective tops of the fluid reservoirs 580, 582. The actuatable elements 520, 522 can also have respective lower ends 545, 547 proximate to the respective bottoms of the fluid reservoirs 580, 582. In some embodiments, at least one of the actuatable elements 520, 522 can have a height of at least about 2 inches, 4 inches, 5 inches, 6 inches, 8 inches, or ranges encompassing such heights. Other dimensions are also possible.

The actuatable elements 520, 522 can form a substantial portion of the circumference of a lower section 553 of the dispenser 500 (see FIG. 13). In some embodiments, the lower section 553 has an outer perimeter that varies in the direction of the longitudinal axis of the dispenser 500. The actuatable elements 520, 522 can define at least about 70%, 80%, 90%, or 95% of the outer perimeter of the lower section 553, thereby providing a relatively large surface area for convenient engagement by the user. Actuatable elements of other sizes can also be employed. Additionally, the dispenser 500 can have more than two actuatable elements. For example, the dispenser 500 can have three or more actuatable elements, each having a somewhat similar shape and size, if needed or desired.

The pump system 510 of FIG. 15 includes a fluid line 548 disposed within the reservoir 582 for pumping fluid from the reservoir 582 into a foodstuff holding reservoir 591. Fluid in the reservoir 580 can be pumped into the holding reservoir 591 without utilizing a fluid line, such as the fluid line 246 described in connection with FIG. 3A, for example. In some embodiments, including the illustrated embodiment of FIG. 15, a fluid pathway 592 is defined in a manifold system 560. The fluid pathway 592 extends between an inlet 595 and an outlet 597. Fluid from the reservoir 580 can flow into the inlet 595 and along the fluid pathway 592. The fluid then flows out of the outlet 597 into the holding reservoir 591. A fluid line (e.g., a fluid line similar to the fluid line 548 or the fluid line 246 described in connection with FIG. 3A) can define the fluid pathway 592, if needed or desired. The dashed line 600 indicates an exemplary non-limiting position for a fluid line which extends into the reservoir 580.

One or more seals can be formed at one or more selected locations to limit, reduce, or substantially prevent fluid from escaping the dispenser 500. FIG. 16 shows the positions 614, 616, 618, 620 suitable for forming at least some of the seals. Any number of seals can be positioned at various locations to prevent unwanted leaking from the dispenser 500.

The dispensers and its components disclosed herein may be formed through any suitable manufacturing process. For example, the outer body of the dispenser can be formed through a machining process, molding process (e.g., an injection molding process), stamping process, combinations thereof, and the like. The various methods and techniques described above provide a number of ways to carry out the illustrative embodiments. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

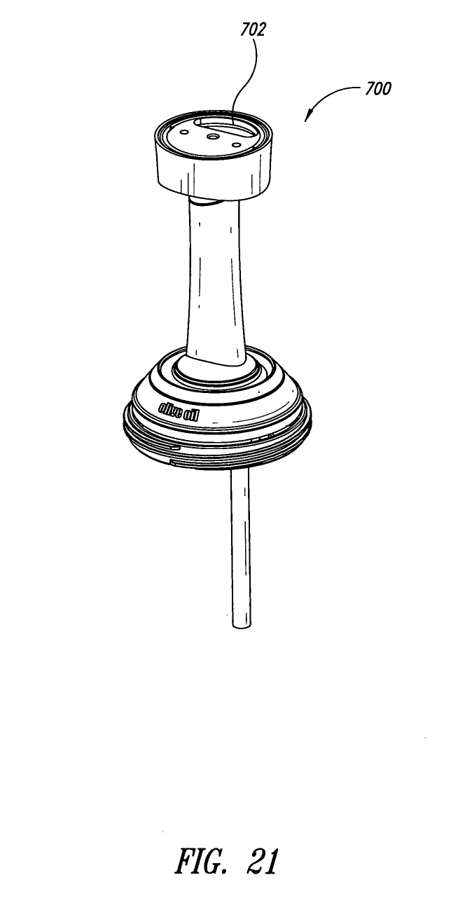

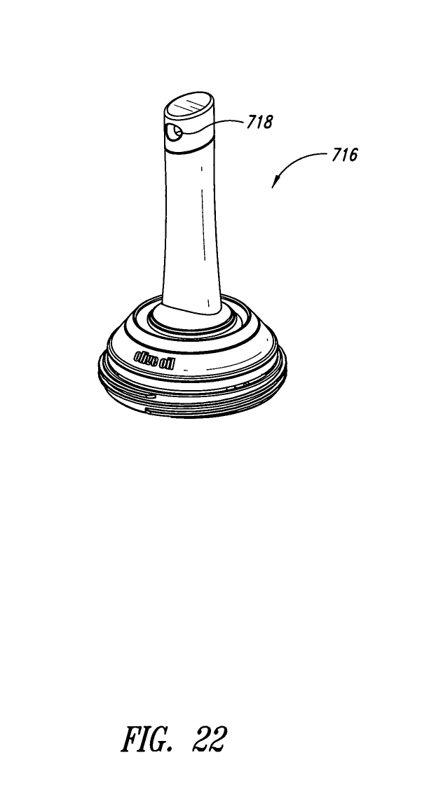

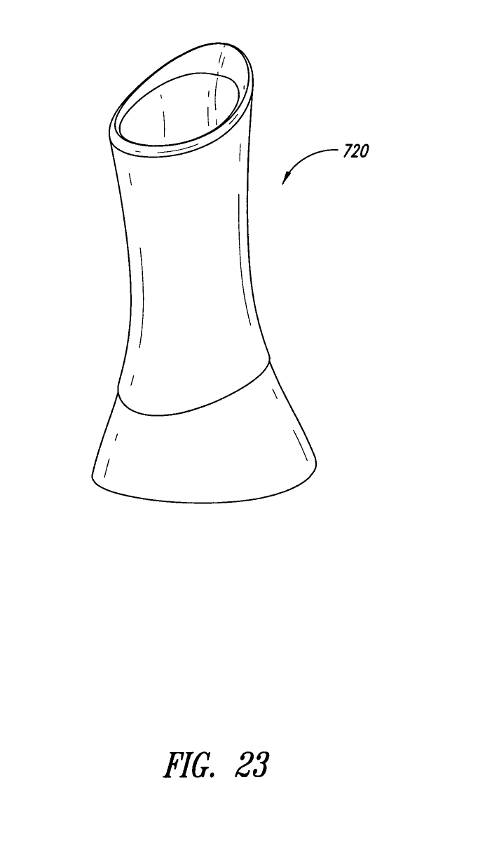

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. For example, the number of reservoirs and size of the holding chamber can be chosen based on the number and type of substances to be mixed. The configuration of the dispensers and their components can be varied based on the intended use. FIG. 21 illustrates a manifold 700 that has a pour spout 702. FIG. 22 shows another slender manifold 716 with a large port 718 through which a high viscosity liquid, such as olive oil, can flow. FIG. 23 illustrates a portion 720 of a dispenser without a lid. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof.

What is claimed is:

1. A handheld pitcher comprising:
a main body having an opening and a bottom opposing the opening;
a plurality of liquid holding reservoirs inside of the main body, each of the liquid holding reservoirs fluidly separated from each of the other liquid holding reservoirs;
a mixing chamber disposed in the main body and in fluid communication with the plurality of liquid holding reservoirs, the opening being above the mixing chamber such that fluid in the mixing chamber is poured out of the opening when the handheld pitcher is tilted; and
a fluid flow regulating system configured to independently deliver contents, if any, from each of the liquid holding reservoirs into the mixing chamber.

2. The pitcher of claim 1, further comprising:
at least one flexible curved actuatable element movable between a first position and a second position to drive liquid from one of the reservoirs into the mixing chamber.

3. The pitcher of claim 1, further comprising:
a lid pivotally coupled to the main body, the lid having an open position to pour liquid in the mixing chamber through the opening and a closed position to block the opening of the main body.

4. The pitcher of claim 1, further comprising:
a plurality of manually actuatable elements that surround a substantial portion respective ones of the plurality of liquid holding reservoirs, the plurality of actuatable elements pump fluid from respective liquid holding reservoir when operated.

5. The pitcher of claim 1, wherein the plurality of liquid holding reservoirs is adjacent the bottom of the main body, and the mixing chamber is between the opening of the main body and the plurality of liquid holding reservoirs.

6. The pitcher of claim 1, wherein the main body has a narrowed upper section defining the mixing chamber and a widened lower section housing the plurality of liquid holding reservoirs.

7. A portable liquid dispenser comprising:
an outer body defining an opening adapted to pour a liquid from the dispenser and a bottom opposing the opening;
a plurality of liquid holding receptacles in the outer body;
a collection chamber in the outer body and in fluid communication with the opening; and
a pumping system configured to deliver liquids from each of the plurality of holding receptacles into the collection chamber.

8. The dispenser of claim 7, further comprising:
a lid movable between an open position to pour liquid through the opening and out of the dispenser and a closed position to block the opening.

9. The dispenser of claim 7, wherein the pumping system includes a plurality of flexible walls of respective ones of the liquid holding receptacles such that liquid in a respective one of the receptacles is delivered into the collection chamber when the wall of the respective receptacle is moved a desired amount.

10. The dispenser of claim 7, wherein the pumping system comprises at least one actuatable element for engaging a respective one of the liquid holding receptacles, the at least one actuatable element movable between a first position and a second position to drive liquid in the respective receptacle into the collection chamber.

11. The dispenser of claim 7, wherein the pumping system comprises a plurality of conduits in which fluid from the liquid holding receptacles flows through and into the collection chamber.

12. The dispenser of claim 7, further comprising:
a manifold system extending into the collection chamber, the manifold system disposed vertically between the plurality of liquid holding receptacles and the opening when the bottom of the main body rests on a support surface.

13. The dispenser of claim 7, wherein the main body is slender and stands vertically upright such that the collection chamber is above the plurality of liquid holding receptacles when the bottom rests on a horizontal support surface.

14. The dispenser of claim 7, wherein the collection chamber is positioned between the opening and at least a portion of the plurality of liquid holding receptacles.

15. The dispenser of claim 7, wherein the plurality of liquid holding receptacles together have a combined holding volume that is greater than a holding volume of the collection chamber.

16. A handheld liquid dispenser comprising:
a body defining an upper opening in which fluid can flow through, a bottom adapted to rest on a support surface, an upper body portion adjacent the opening, and a lower body portion adjacent the bottom;
a plurality of internal reservoirs in the lower body portion;
a chamber in the upper body portion, the chamber in fluid communication with the opening; and
a plurality of fluid channels extending from the plurality of reservoirs to the chamber.

17. The liquid dispenser of claim 16, further comprising:
a plurality of fluid lines defining respective ones of the fluid channels such that liquids in the plurality of reservoirs are independently deliverable into the chamber.

18. The liquid dispenser of claim 16, further comprising:
a fluid flow control system operable to selectively deliver a desired amount of liquid from each of the plurality of reservoirs into the chamber.

19. The liquid dispenser of claim 16, further comprising:
a plurality of actuatable elements positioned along the body, each of the actuatable elements movable inwardly to pump fluid in one of the reservoirs along one of the fluid channels and into the chamber.

20. The liquid dispenser of claim 16, wherein one of the reservoirs contains a first edible fluid and another of the reservoirs contains a second edible fluid that is different from the first edible fluid.

21. The liquid dispenser of claim 20, wherein the first edible fluid is olive oil and the second edible fluid is vinegar.

22. A method of preparing a mixture in a handheld bottle, the method comprising:
independently delivering liquids from a plurality of liquid holding reservoirs in an outer body of the handheld bottle into a collection chamber of the handheld bottle to produce a mixture; and
delivering the mixture out of the bottle by pouring the mixture through an opening of the bottle.

23. The method of claim 22, further comprising:
operating a pump system of the bottle to independently deliver the liquids from the plurality of the liquid holding reservoirs into the collection chamber.

24. The method of claim 22, wherein operating the pump system comprises manually moving at least one actuatable element from a first position to a second position.

25. The method of claim 22, wherein the mixture comprises oil and vinegar.
